(19) United States
(12) Patent Application Publication
(10) Pub. No.: US 2014/0113268 A1
(43) Pub. Date: Apr. 24, 2014

(54) INTERACTIVE VISUAL ASSESSMENT AFTER A REHEARSAL OF A PRESENTATION

(71) Applicant: MICROSOFT CORPORATION, Redmond, WA (US)

(72) Inventors: Abhishek Dhasmana, Hyderabad (IN); Atish Patel, Mumbai (IN)

(73) Assignee: MICROSOFT CORPORATION, Redmond, WA (US)

(21) Appl. No.: 13/657,591

(22) Filed: Oct. 22, 2012

(51) Int. Cl. G09B 25/00

(52) U.S. Cl. 434/365

(57) ABSTRACT

A rehearsal mode is used to rehearse presentations. While in rehearsal mode, a time spent rehearsing each portion of the presentation (e.g. each slide) is determined. A user may also tag a portion of the presentation during the rehearsal. When the user finishes the rehearsal, an interactive performance assessment for the rehearsal is displayed. The performance assessment visually displays a graphical indicator (e.g. a graphical bar) for each of the portions of the presentation that includes a time spent on each portion. A user may interact with the performance assessment. For example, a user may drill down into the performance assessment and show more detail, set a time target for a portion of the presentation, and the like. When the user rehearses the presentation, the time targets are used to provide user feedback (e.g. haptic/visual) to indicate if more time is spent on the slide than the user set.

### BACKGROUND

Many people spend a lot of time rehearsing for a presentation. For example, a person may rehearse a slide presentation by navigating and speaking through each of the slides while sitting or standing by their desktop computer. Assessing the person's performance of the rehearsal of the presentation can be challenging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A rehearsal mode is used to rehearse presentations that includes an interactive performance assessment. The rehearsal mode may be entered on a mobile device and/or a desktop computing device. While in rehearsal mode, a time spent rehearsing each portion of the presentation (e.g. each slide) is determined. A user may also tag portions of the presentation during the rehearsal. For example, a user may tag a slide of a presentation in order to highlight a particular slide during an interactive performance assessment and/or to mark its importance. When the user finishes the rehearsal, the interactive performance assessment for the rehearsal is displayed. The interactive performance assessment may be displayed automatically/manually at the end of the rehearsal. The performance assessment visually displays a graphical indicator (e.g. a graphical bar) for each of the portions of the presentation. The graphical indicator is displayed such that the time spent on the portion during the rehearsal can be readily determined from the performance assessment. For example, each graphical indicator may be sized based on the time spent on that portion during the rehearsal. Any tagged portions are distinguished from other portions (e.g. highlight the graphical bar, show an icon . . . ). A user may interact with the performance assessment. For example, a user may drill down into the performance assessment and show more detail, set a time target for a portion of the presentation, move to a specific portion of the presentation, delete a specific portion of the presentation, and the like. When the user rehearses the presentation after setting time targets, the time targets are used to provide user feedback (e.g. haptic/visual) to indicate if more time is spent on the slide than the user set.

### BRIEF DESCRIPTION OF THE DRAWINGS

FIG. 1 shows a system for rehearsing a presentation and displaying an interactive performance assessment;

FIG. 2 shows a view during a rehearsal of a presentation and a view at the end of the rehearsal;

FIG. 3 illustrates a display of an interactive performance assessment;

FIG. 4 illustrates setting a target time for a portion of the presentation;

FIG. 5 illustrates a drill down view;

FIG. 6 illustrates setting a target time for a portion of the presentation when in the drill down view;

FIG. 7 illustrates temporarily displaying more detail within the interactive performance assessment for a particular portion of a presentation;

FIG. 8 shows an illustrative processes for rehearsing a presentation and displaying an interactive performance assessment;

FIG. 9 shows a diagram illustrating processing different interactions with the performance assessment;

FIG. 10 illustrates an exemplary system for a rehearsal mode and display of a performance assessment; and

FIGS. 11-13 and the associated descriptions provide a discussion of a variety of operating environments in which embodiments of the invention may be practiced.

### DETAILED DESCRIPTION

Referring now to the drawings, in which like numerals represent like elements, various embodiment will be described.

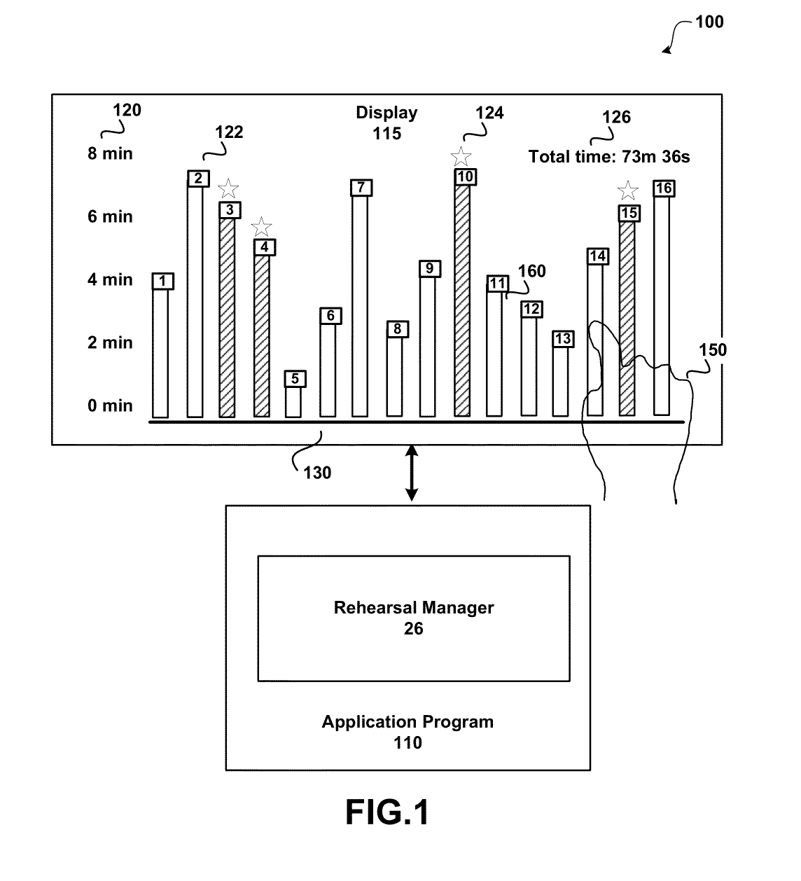

FIG. 1 shows a system for rehearsing a presentation and displaying an interactive performance assessment. As illustrated, system 100 includes application program 110, rehearsal manager 26 and touch screen input device/display 115.

In order to facilitate communication with the rehearsal manager 26, one or more callback routines, may be implemented. According to one embodiment, application program 110 is a presentation application, such as a slide presentation program, that is configured to receive input from a touch-sensitive input device 115 and/or other input devices. For example, voice input, keyboard input (e.g. a physical keyboard and/or SIP), video based input, and the like. For example, rehearsal manager 26 may provide information to application 110 in response to a user's gesture (i.e. gesture 150) selecting content and other touch based gestures. For example, gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action; and the like.

System 100 as illustrated comprises a touch screen input device/display 115 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Rehearsal manager 26 is configured to record information during a rehearsal of a presentation and display an interactive performance assessment after the rehearsal. In response to receiving an instruction to enter a rehearsal mode (e.g. receiving a selection gesture, command, . . . ), rehearsal manager 26 enters the rehearsal mode. In the current example, the user has finished rehearsing a slide presentation and an interactive performance assessment is shown on display 115. Similarly, rehearsal manager 26 may exit the rehearsal mode in response to different events (e.g. selection by the user, and the like).

The rehearsal mode may be entered on a mobile device and/or a desktop computing device. Rehearsing a presentation using a mobile computing device allows the user to move freely during the rehearsal as well as to rehearse in different environments as compared to being tied to a desktop computing device. While in rehearsal mode, a time spent rehearsing each portion of the presentation (e.g. each slide) is determined. A user may also tag a portion of the presentation during the rehearsal. For example, a user may tap on an option to tag a slide of a presentation during the rehearsal in order to highlight a particular slide for later review. For example, to adjust the time target for the slide, to edit the slide, delete the slide, move the slide, and the like.

When the user finishes the rehearsal, an interactive performance assessment for the rehearsal is displayed as illustrated on display 115. The interactive performance assessment may be displayed automatically/manually at the end of the rehearsal. The performance assessment visually displays a graphical indicator (e.g. a graphical bar) for each of the portions of the presentation. The graphical indicator is displayed such that the time spent on the portion during the rehearsal can be readily determined (e.g. each graphical indicator is sized based on the time spent on that portion during the rehearsal). In the current example, each portion of the presentation is shown with an indicator, such as graphical indicator 122, showing the portion of the presentation represented by the graphical bar (e.g. 1 for slide 1, 2 for slide 2 . . . ). The graphical indicator may also be distinguished from other graphical indicators when the portion of the presentation was tagged during the rehearsal (e.g. a graphical icon such as a star icon 124 and/or displaying the graphical bar differently, such as by highlighting the bar, filling the bar, . . . ).

A user may interact with the performance assessment. For example, a user may drill down into the performance assessment and show more detail, move to a specific portion of the presentation, delete a specific portion of the presentation, set a time target for a portion of the presentation, and the like. When the user rehearses the presentation, the time targets are used to provide user feedback (e.g. haptic/visual) to indicate if more time is spent on the slide than the user set. More details regarding the interactive performance assessment are provided below.

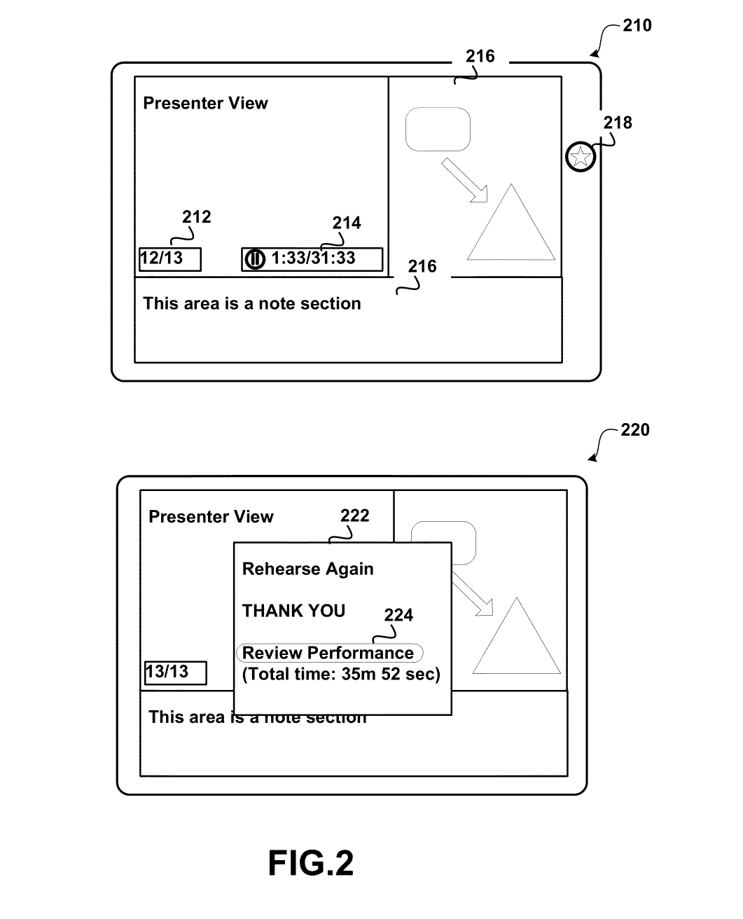

FIG. 2 shows a view during a rehearsal of a presentation and a view at the end of the rehearsal. As illustrated, FIG. 2 includes two different displays (210 and 220). The displays may be shown on displays having a standard/large display (e.g. displays larger than 12 inches) as well as a device having a limited display size (e.g. a cell phone having a display of approximately 2 by 3 inches, a slate/tablet having approximately a 7-10 inch display, and/or other devices having other display sizes (e.g. 4, 5, 6). The displays may also be shown on a touch screen.

Display 210 shows a display of a portion of a presentation while rehearsing for a presentation. In the current example, the portion of the presentation is a slide. The portion of the presentation may come from other applications besides a slide presentation application. For example, sections of a word-processing document, sheets from a spreadsheet workbook, web pages, and the like. In the current example, display 210 shows a view of a slide that includes a presenter view, a current number of the slide 212, a time indicator showing an overall time and a current time for the slide 214, a notes section 216 and a view 216 as seen by an audience during the presentation. A user may pause the rehearsal by selecting/tapping on the pause button as well as resume a paused presentation and/or exit the rehearsal. Other indicators may also be shown on the display during a rehearsal. For example, a user may select a tag option 218 to tag the slide for later review using an interactive performance assessment display.

Display 220 shows an exemplary display at the end of the rehearsal. As illustrated, display 220 includes a rehearsal end section 222 that provides the user with a total time spent on the rehearsal as well as a selectable option 224 to review the performance. According to an embodiment, the performance assessment is automatically displayed at the end of the rehearsal.

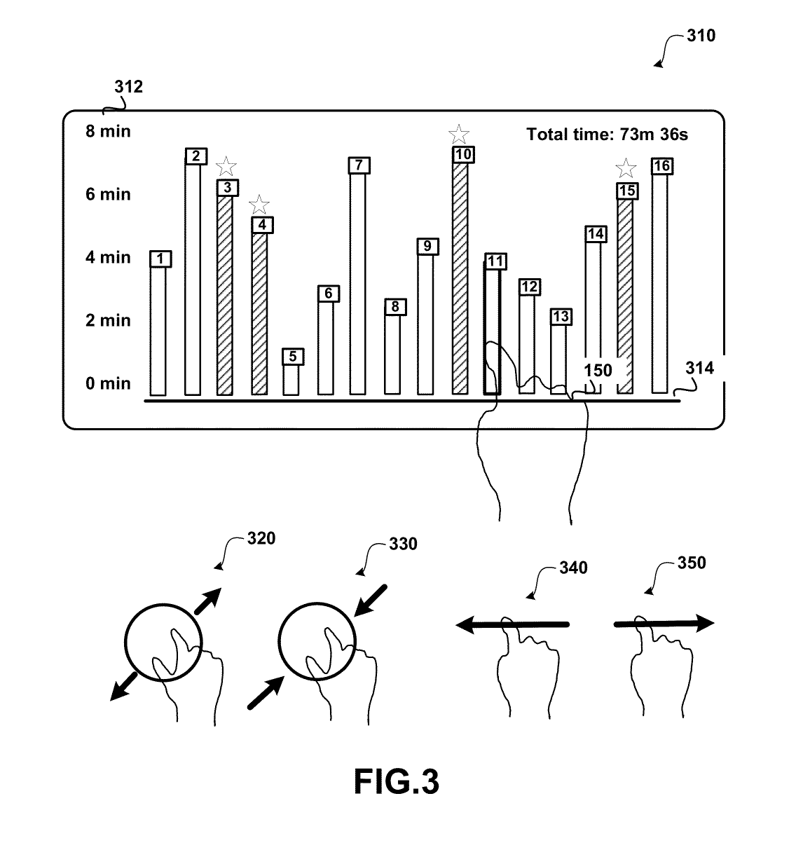

FIG. 3 illustrates a display of an interactive performance assessment. As illustrated, FIG. 3 includes display 310 and exemplary gestures 320, 330, 340 and 350.

Display 310 shows an interactive performance assessment for a rehearsal that displays a time axis 312 and a slide axis 314. Each slide in the presentation is displayed as a graphical bar that is sized according to the time spent on the slide during the rehearsal.

Each of the slides that was tagged (slides 3, 4, 10, and 15) is distinguished from the non-tagged slides. In the current example, a bar is shown in a different color from the other bars when the corresponding slide is tagged. A star indicator is also shown above the display of the bar when the slide is tagged. Other display methods may be used to distinguish a tagged portion of a presentation. For example, the bar may be filled differently, the bar may be highlighted, a border may be thicker, a different indicator may be displayed, and the like. A slide may be tagged during the rehearsal of the presentation as well as using the performance assessment display.

The performance assessment display 310 may make it very useful for the user to perform a better presentation since the user can easily compare and analyze which slide(s) where the user is spending more time in the presentation as compared to the time spent on important slides. This performance assessment visualization 310 is directed at displaying rehearsal information in an intuitive manner such that the user can more easily assess their performance as compared to just providing mundane numbers. Additionally, the interactivity may make it easy for the user to assess and rectify the timing of the presentation. For example, the user may notice that more time is spent on slides 2 and 7 that are not as beneficial in the presentation as the tagged slides.

Different touch based gestures may be used to interact with the performance assessment. For example, a user 150 may tap a portion of the presentation (e.g. slide 11) to select the portion. After selection, the user may perform other operations with the selection. For example, the user may tap the portion again to display a more detailed view, display a menu with selectable options (e.g. tag, move, delete, change time, make note, edit . . . ), drag and drop the portion to another location within the presentation, and the like.

According to another embodiment, a user may perform a tap and hold gesture to interact with the portion of the presentation. According to an embodiment, a user 150 may select a bar and then perform a drag touch gesture to adjust the size of the bar on the display. When the user has sized the bar, a time target is set for that portion of the content. The time target may be displayed during another rehearsal to help provide the user with feedback during the rehearsal. For example, when the target time is being met, the rehearsal display may be displayed in a normal mode, when the target time is nearing a target time the rehearsal display may be displayed in a caution mode (e.g. an indicator flashing yellow, the mobile device may vibrate at predetermined intervals, . . . ), and when the target time is passed the rehearsal display may be displayed in a time exceeded mode (e.g. an indicator flashing red, the mobile device constantly vibrating . . . ).

A user may also change the detail that is displayed in the interactive performance assessment. For example, a user may perform a stretch gesture 320 to display a more detailed view (e.g. a drill down view) or perform a pinch gesture 330 to display less detail.

A user may also move the portions of the presentation that are displayed in the interactive performance assessment when each portion is not displayed within the current view. For example, a user may perform a left swipe gesture 340 or a right swipe gesture 350 to navigate the portions.

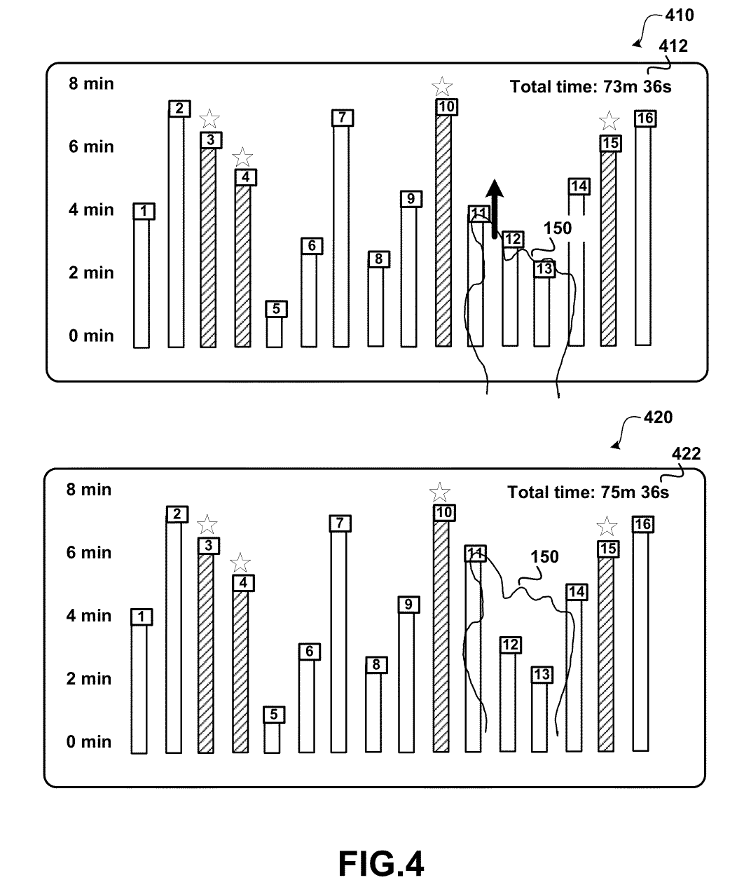

FIG. 4 illustrates setting a target time for a portion of the presentation. As illustrated, FIG. 4 includes display 410 and 420.

According to an embodiment, a user taps and drags one of the bars to adjust the size of the bar. In the current example, user 150 taps and holds on slide 11 in display 410 and performs an upward drag operation to increase a target time for the slide.

Display 420 shows the user 150 adjusting the target time up to 6 minutes as compared to 4 minutes as shown in display 410. In response to the adjustment, the overall time is adjusted to reflect the new target time as illustrated by time display 412 to time display 422.

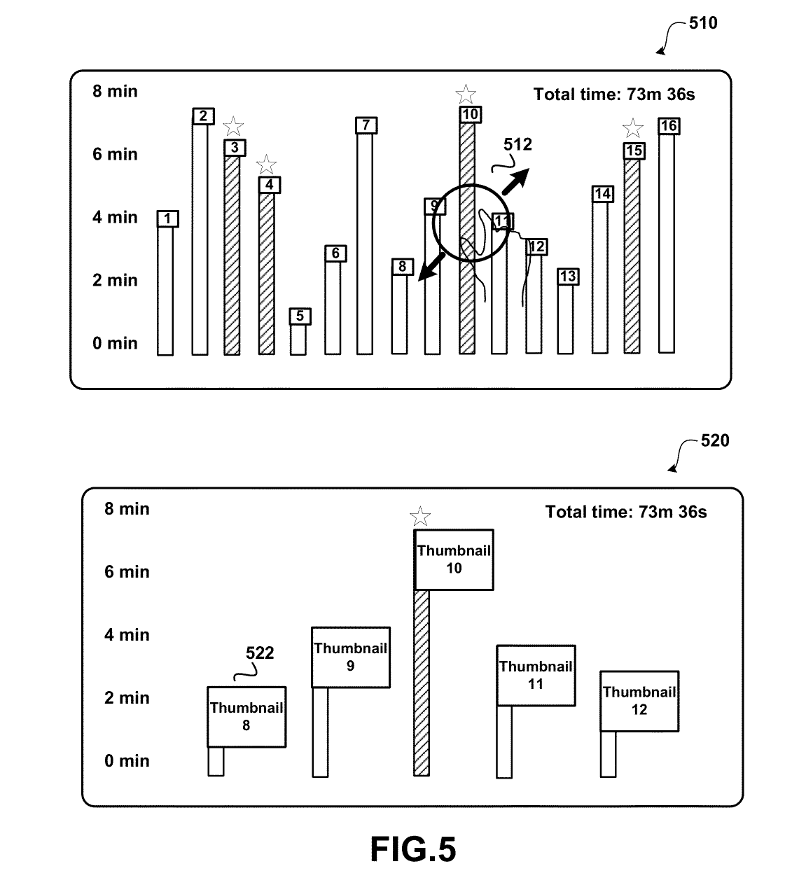

FIG. 5 illustrates a drill down view. As illustrated, FIG. 5 includes display 510 and 520.

Display 510 illustrates an interactive performance assessment display before a drill down view is displayed. In the current example, a user is performing a stretch tough gesture 512 to move to a drill down view. The drill down view may be entered using other methods (e.g. selecting a menu option, tapping on a bar, tapping on an already selected bar, and the like).

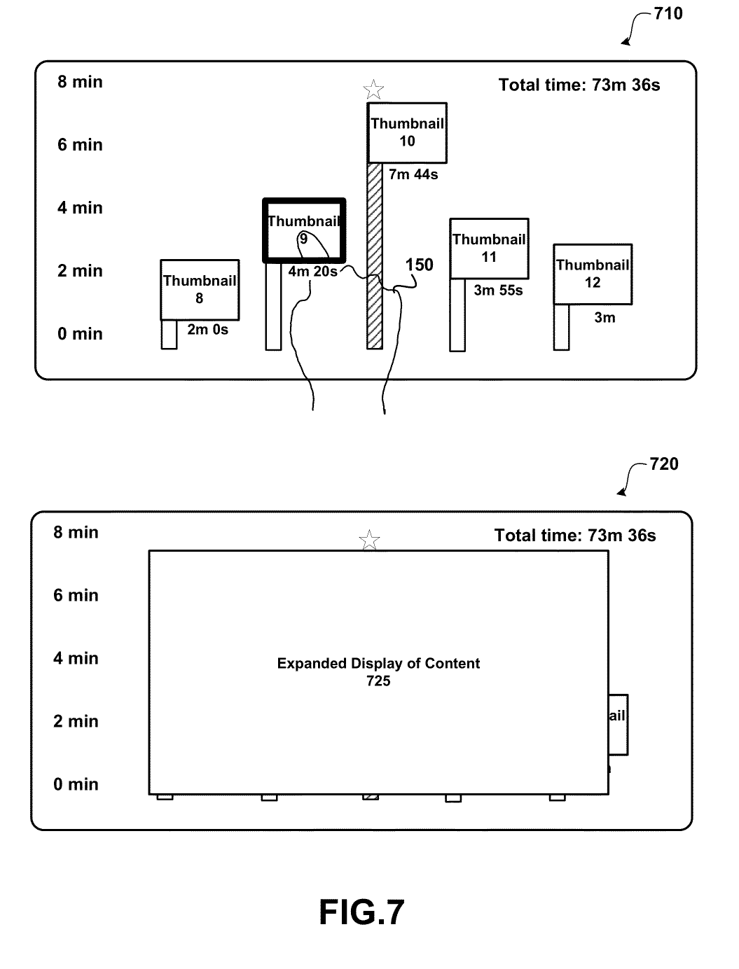

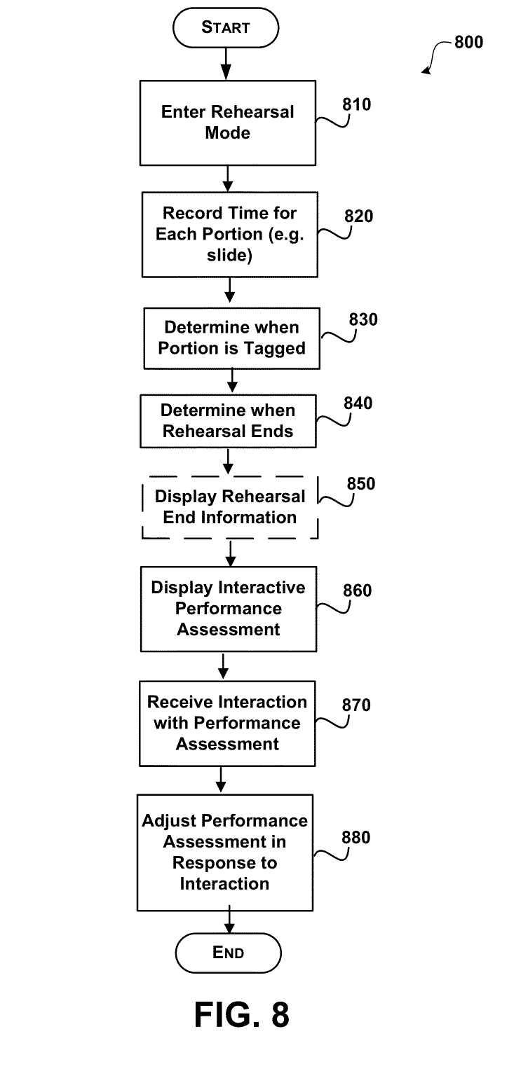

Display 520 shows a drill down view of portions of the presentation. The drill down view 520 shows an expanded view of content for the presentation. In the current example, a thumbnail (such as thumbnail 522) is displayed along with each bar that provides a scaled down view of the portion of content that is associated with the bar. The detail displayed by the thumbnail may change based on the available display area of the device as well as the number of bars shown within the performance assessment. For example, when fewer bars are shown the thumbnail may be a zoomed display of the slide and when more bars are shown the thumbnail may be a graphical representation of the content associated with the slide (e.g. a chart icon when the slide includes a chart, a text icon when the slide is mainly text, a spreadsheet icon when the slide is a spreadsheet, and the like). Instead of having to exit the performance assessment view, the user may simply use a drill down gesture (e.g. tap and hold, pinch/stretch on the thumbnails) to view more content associated with the thumbnail (See FIG. 7).

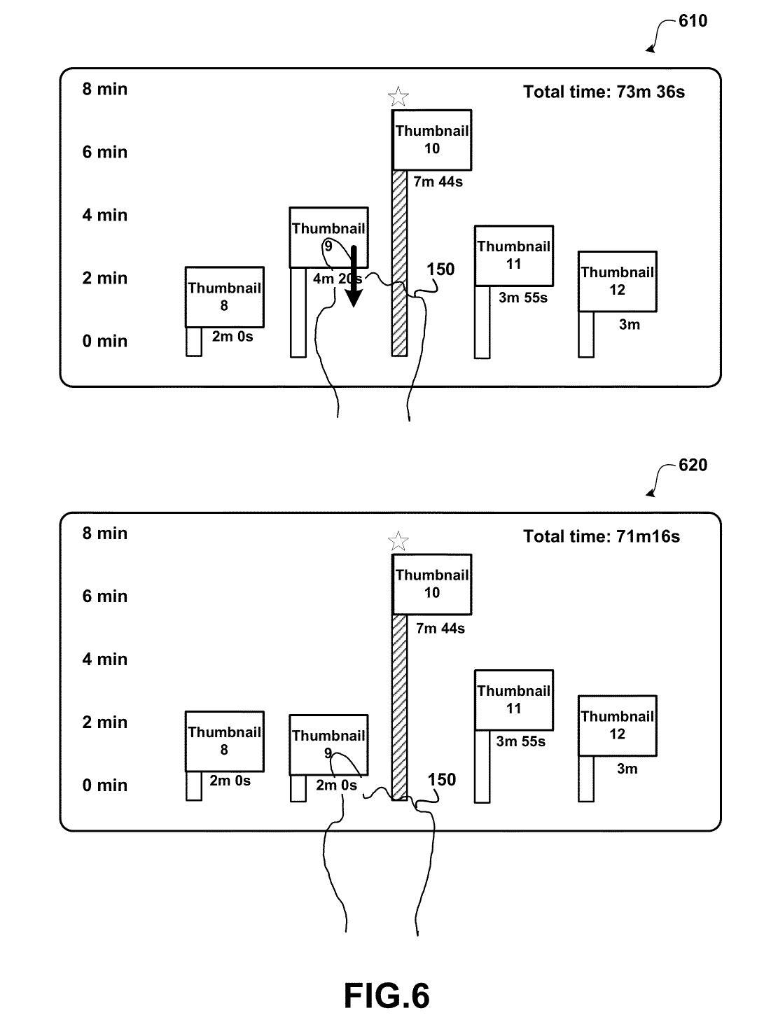

FIG. 6 illustrates setting a target time for a portion of the presentation when in the drill down view. As illustrated, FIG. 6 includes display 610 and 620.

According to an embodiment, a user taps and drags one of the thumbnails displayed on the bar to adjust the target time. In the current example, user 150 taps and holds on the thumbnail associated with portion 9 in display 510 and performs an downward drag operation to decrease a target time for the slide.

Display 520 shows the user 150 adjusting the target time from 4 minutes 20 seconds down to 2 minutes 0 seconds. In response to the adjustment, the overall time is adjusted from 73 minutes 36 seconds to 71 minutes 16 seconds to reflect the new target time.

In the current example, the current time that is associated with the portion of content is shown with the thumbnail. This may benefit the user of a limited display device to more easily be able to determine how to adjust the time without having to select other options to display the time information.

FIG. 7 illustrates temporarily displaying more detail within the interactive performance assessment for a particular portion of a presentation. As illustrated, FIG. 7 includes display 710 and 720.

Display 710 illustrates user 150 tapping on selected thumbnail to display a more detailed view of content that is associated with the portion of the presentation represented by thumbnail 9. Other gestures may be used to display the expanded display as illustrated in display 720. For example, a tap and hold gesture, a pinch/stretch gesture, a selection of a menu item, and the like.

Display 720 shows an expanded view of the selected portion of the presentation. According to an embodiment, a full size view of the portion of the presentation is attempted to be displayed when the size and resolution of the display device is capable of displaying the full size view. According to another embodiment, the expanded display of content 725 is sized to fit a predetermined percentage of the interactive performance assessment display (e.g. 50-98%). According to an embodiment, a user may exit the expanded display by tapping on another area of the display.

FIG. 8 shows an illustrative processes 800 for rehearsing a presentation and displaying an interactive performance assessment. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process moves to operation 810, where a rehearsal mode is entered for a presentation. The presentation may include different portions of content. For example, the portions may be slides, pages, images, document sections, headings, and other discrete portions of content upon which a presentation is based. According to an embodiment, a touch input gesture (e.g. tapping a User Interface (UI) element) is received to enter the rehearsal mode.

Flowing to operation 820, the presentation is rehearsed by the user. For example, the user may practice rehearsal for each of the slides of a presentation. During the rehearsal, a time spent on each of the portions (e.g. slides) of the presentation is determined (e.g. two minutes on slide one, five minutes on slide two, three and a half minutes on slide three . . . ).

Moving to operation 830, a determination is made as to whether a portion of the rehearsal currently being rehearsed is tagged. For example, a user may perform a gesture (e.g. tap on a tag UI element) to tag a slide during a rehearsal of the slide.

Transitioning to operation 840, a determination is made that the rehearsal for the presentation has ended. The rehearsal may end in response to reaching an ending point in the presentation (e.g. reaching last slide) and/or in response to an input from the user (e.g. tapping on an end rehearsal option).

Flowing to optional operation 850, a summary of rehearsal information may be displayed. According to an embodiment, a total time spent on the rehearsal is provided along with a selectable option to display an interactive performance assessment visualization. According to another embodiment, the performance assessment visualization is automatically entered.

Transitioning to operation 860, the interactive performance assessment is displayed. According to an embodiment, the performance assessment visualization displays a graphical indictor for each portion of the presentation (e.g. a bar chart, a pie chart, a line chart, . . . ).

Moving to operation 870, interaction with the performance assessment is received. The interaction may be different types of interactions. For example, the interaction may be received to show a drill down view, adjust a target time for a portion of the content, tag a portion of the content, as well as perform other operations (e.g. move, delete, edit, make a note, and the like).

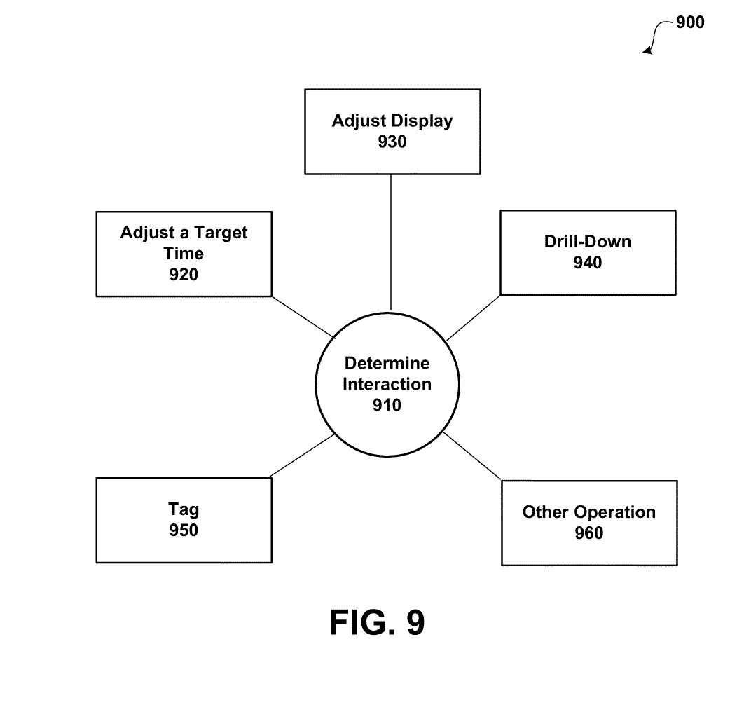

Flowing to operation 880, the display of the performance assessment is adjusted in response to receiving an interaction. When the interaction is a drill down interaction, more detail is displayed (e.g. show a thumbnail for each portion of the presentation). When the interaction is a target time adjustment, the visual display of the bar associated with the portion of content is adjusted. More details are provided in FIG. 9. The process then moves to an end operation and returns to processing other actions.

FIG. 9 shows a diagram illustrating processing different interactions with the performance assessment.

Operation 910 determines when an interaction with the performance assessment is received. For example, a touch gesture may be received. According to an embodiment, the gesture may relate to adjusting a target time, adjusting the display (e.g. panning/zooming), drilling down, performing another operation and tagging a portion of the presentation. For example, a zooming action may be associated with a pinch/stretch gesture. A panning action may be associated with a swipe gesture. A drill-down action may be associated with a tap and hold gesture and/or a pinch/stretch gesture. A select action may be associated with a tap gesture. Other gestures may be associated with the actions.

When the gesture is an adjust target time action 920, the target time that is associated with the portion of the presentation is adjusted and visually displayed. For example, a user may select a bar representing a slide and drag the top of the bar higher to adjust a target time for the slide to provide more time during the presentation and drag the top of the bar lower to adjust the target time for the slide to provide less time during the presentation. According to another embodiment, a user may provide text/speech input to adjust the target time for a portion of the presentation.

When the gesture is associated with an adjust display action 930, the display of the graphical indicators (e.g. bars) is updated. For example, when not all of the bars for a presentation fit within the available viewing space, a pan gesture (e.g. a left/right swiping touching gesture) may be used to change the currently displayed bars. A zoom gesture may also be received. For example, a user may perform a pinch/stretch gesture to display more content with each of the bars.

When the gesture is associated with a drill-down action 940, an expanded view of the content associated with each bar is shown (e.g. a thumbnail) is shown. According to an embodiment, when a thumbnail is already shown, a further drill-down displays a larger thumbnail and/or the entire portion of the presentation.

When the gesture is associated with a tag action 950, the bar is tagged and the display of the performance assessment is updated to reflect the tagging.

When the gesture is associated with another action (e.g. tap and hold to display a menu, tap to display a menu) the action is performed. For example, the action may be to display a menu and receive a selection of an option (e.g. move, delete, edit . . . ). Other gestures may also be performed. For example, a bar may be moved using a drag and drop operation that adjusts the location of the portion of the presentation.

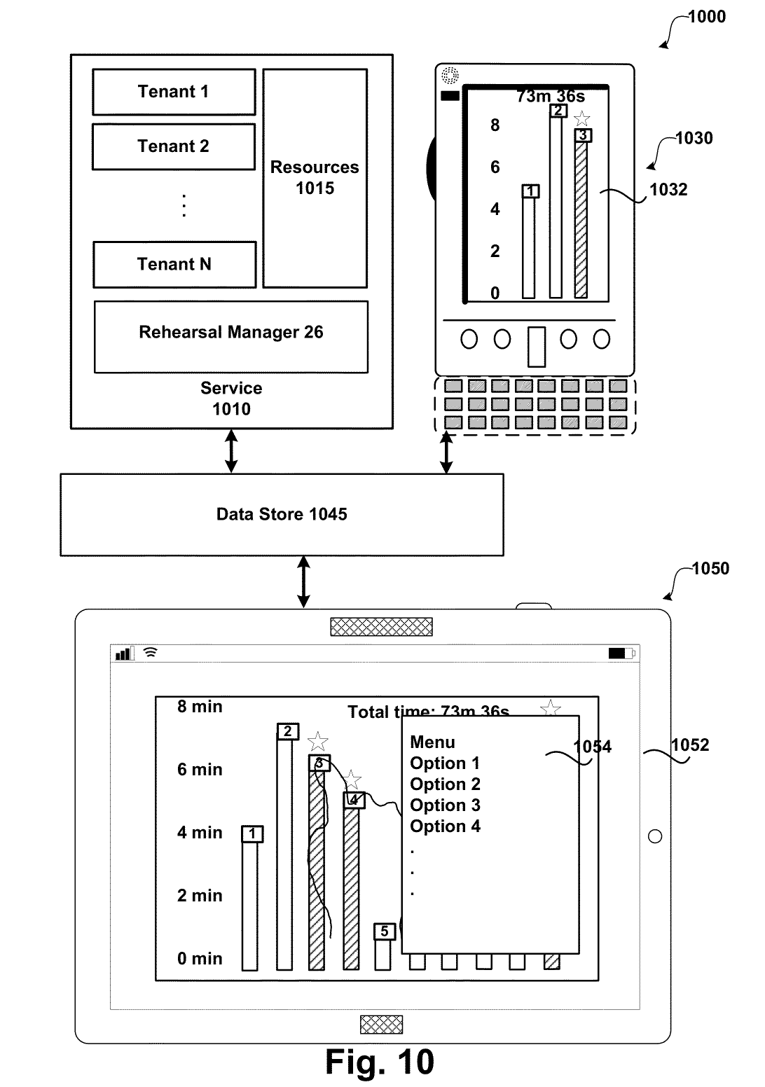

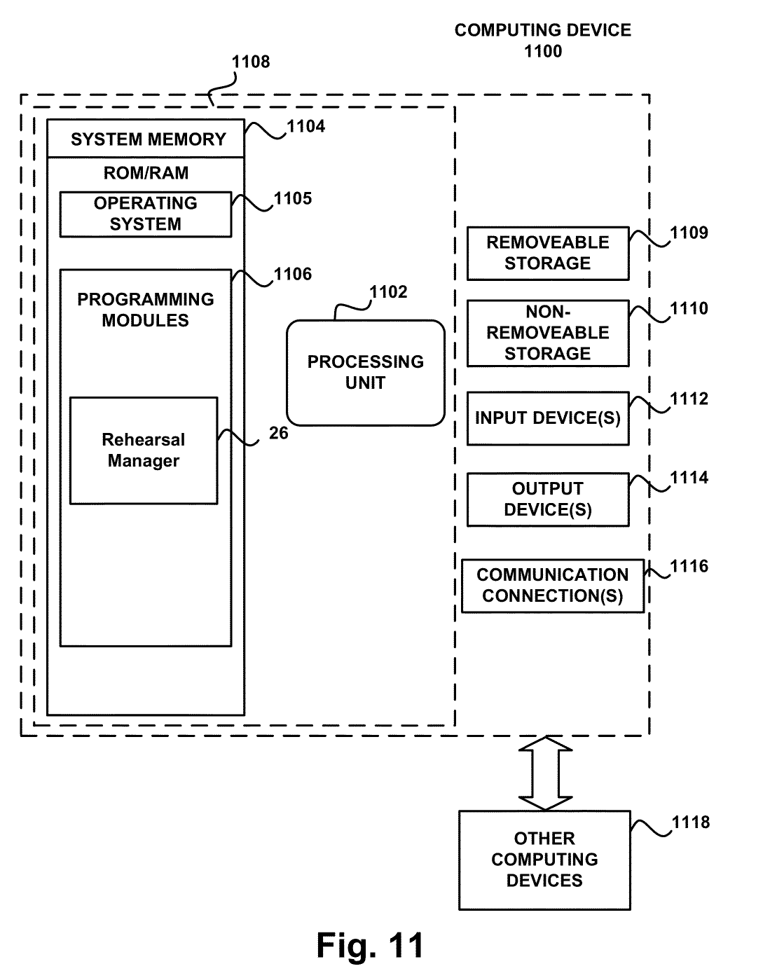

FIG. 10 illustrates an exemplary system for a rehearsal mode and display of a performance assessment. As illustrated, system 1000 includes service 1010, data store 1045, touch screen input device/display 1050 (e.g. a slate) and smart phone 1030.

As illustrated, service 1010 is a cloud based and/or enterprise based service that may be configured to provide services, such as presentation services/productivity services (e.g. MICROSOFT OFFICE 365 or some other cloud based/online service that is used to interact with content (e.g. spreadsheets, documents, presentations, charts, messages, and the like) and be utilized in presentations. The service may be interacted with using different types of input/output. For example, a user may use touch input, hardware based input, speech input, and the like. The service may provide speech output that combines pre-recorded speech and synthesized speech. Functionality of one or more of the services/applications provided by service 1010 may also be configured as a client/server based application. Although system 1000 shows a service relating to a presentation application, other services/applications may be configured.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device/display 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030 and touch screen input device/display 1050 are configured with presentation applications.

As illustrated, touch screen input device/display 1050 and smart phone 1030 shows exemplary displays 1052/1032 showing the use of an application using a rehearsal mode to rehearse a presentation and display an interactive performance assessment after the rehearsal. Display 1052 illustrates a user performing a tap and hold gesture to display menu 1054. Data may be stored on a device (e.g. smart phone 1030, slate 1050 and/or at some other location (e.g. network data store 1045). The applications used by the devices may be client based applications, server based applications, cloud based applications and/or some combination.

Rehearsal manager 26 is configured to perform operations relating to rehearsing a presentation and displaying an interactive performance assessment as described herein. While manager 26 is shown within service 1010, the functionality of the manager may be included in other locations (e.g. on smart phone 1030 and/or slate device 1050).

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 11-13 and the associated descriptions provide a discussion of a variety of operating environments in which embodiments of the invention may be practiced. However, the devices and systems illustrated and discussed with respect to FIGS. 11-13 are for purposes of example and illustration and are not limiting of a vast number of computing device configurations that may be utilized for practicing embodiments of the invention, described herein.

FIG. 11 is a block diagram illustrating example physical components of a computing device 1100 with which embodiments of the invention may be practiced. The computing device components described below may be suitable for the computing devices described above. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a web browser application 1120. Operating system 1105, for example, may be suitable for controlling computing device 1100's operation. In one embodiment, programming modules 1106 may include a rehearsal manager 26, as described above, installed on computing device 1100. Furthermore, embodiments of the invention may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated by a removable storage 1109 and a non-removable storage 1110.

As stated above, a number of program modules and data files may be stored in system memory 1104, including operating system 1105. While executing on processing unit 1102, programming modules 1106, such as the manager may perform processes including, for example, operations related to methods as described above. The aforementioned process is an example, and processing unit 1102 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 26 may be operated via application-specific logic integrated with other components of the computing device/system 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

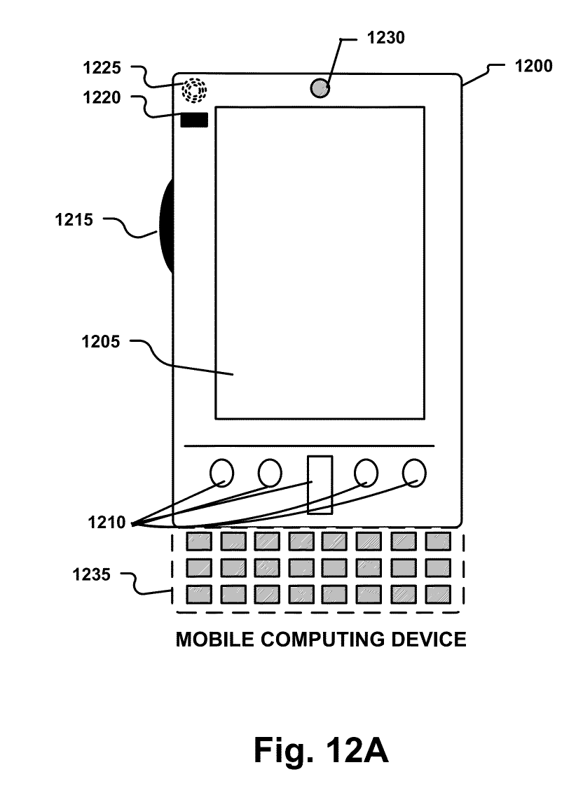

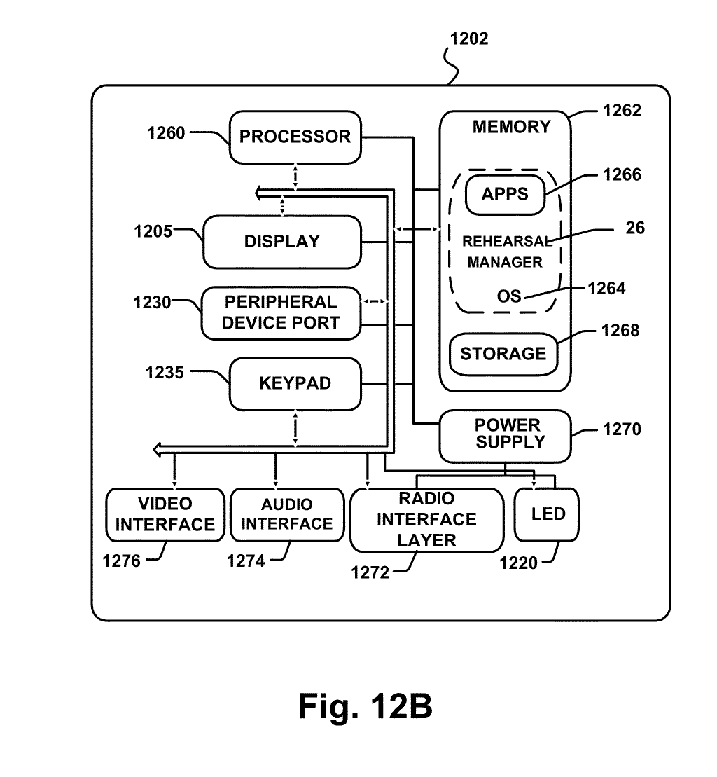

FIGS. 12A and 12B illustrate a suitable mobile computing environment, for example, a mobile telephone, a smartphone, a tablet personal computer, a laptop computer, and the like, with which embodiments of the invention may be practiced. With reference to FIG. 12A, an example mobile computing device 1200 for implementing the embodiments is illustrated. In a basic configuration, mobile computing device 1200 is a handheld computer having both input elements and output elements. Input elements may include touch screen display 1205 and input buttons 1215 that allow the user to enter information into mobile computing device 1200. Mobile computing device 1200 may also incorporate an optional side input element 1215 allowing further user input. Optional side input element 1215 may be a rotary switch, a button, or any other type of manual input element. In alternative embodiments, mobile computing device 1200 may incorporate more or less input elements. For example, display 1205 may not be a touch screen in some embodiments. In yet another alternative embodiment, the mobile computing device is a portable phone system, such as a cellular phone having display 1205 and input buttons 1215. Mobile computing device 1200 may also include an optional keypad 1235. Optional keypad 1215 may be a physical keypad or a “soft” keypad generated on the touch screen display.

Mobile computing device 1200 incorporates output elements, such as display 1205, which can display a graphical user interface (GUI). Other output elements include speaker 1225 and LED light 1220. Additionally, mobile computing device 1200 may incorporate a vibration module (not shown), which causes mobile computing device 1200 to vibrate to notify the user of an event. In yet another embodiment, mobile computing device 1200 may incorporate a headphone jack (not shown) for providing another means of providing output signals.

Although described herein in combination with mobile computing device 1200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 12B is a block diagram illustrating components of a mobile computing device used in one embodiment, such as the computing device shown in FIG. 12A. That is, mobile computing device 1200 can incorporate system 1202 to implement some embodiments. For example, system 1202 can be used in implementing a “smart phone” that can run one or more applications similar to those of a desktop or notebook computer such as, for example, presentation applications, browser, e-mail, scheduling, instant messaging, and media player applications. In some embodiments, system 1202 is integrated as a computing device, such as an integrated personal digital assistant (PDA) and wireless phoneme.

One or more application programs 1266 may be loaded into memory 1262 and run on or in association with operating system 1264. Examples of application programs include phone dialer programs, e-mail programs, PIM (personal information management) programs, word processing programs, spreadsheet programs, Internet browser programs, messaging programs, and so forth. System 1202 also includes non-volatile storage 1268 within memory 1262. Non-volatile storage 1268 may be used to store persistent information that should not be lost if system 1202 is powered down. Applications 1266 may use and store information in non-volatile storage 1268, such as e-mail or other messages used by an e-mail application, and the like. A synchronization application (not shown) may also reside on system 1202 and is programmed to interact with a corresponding synchronization application resident on a host computer to keep the information stored in non-volatile storage 1268 synchronized with corresponding information stored at the host computer. As should be appreciated, other applications may be loaded into memory 1262 and run on the device 1200, including the rehearsal manager 26, described above.

System 1202 has a power supply 1270, which may be implemented as one or more batteries. Power supply 1270 might further include an external power source, such as an AC adapter or a powered docking cradle that supplements or recharges the batteries.

System 1202 may also include a radio 1272 that performs the function of transmitting and receiving radio frequency communications. Radio 1272 facilitates wireless connectivity between system 1202 and the “outside world”, via a communications carrier or service provider. Transmissions to and from radio 1272 are conducted under control of OS 1264. In other words, communications received by radio 1272 may be disseminated to application programs 1266 via OS 1264, and vice versa.

Radio 1272 allows system 1202 to communicate with other computing devices, such as over a network. Radio 1272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1202 is shown with two types of notification output devices; LED 1220 that can be used to provide visual notifications and an audio interface 1274 that can be used with speaker 1225 to provide audio notifications. These devices may be directly coupled to power supply 1270 so that when activated, they remain on for a duration dictated by the notification mechanism even though processor 1260 and other components might shut down for conserving battery power. LED 1220 may be programmed to remain on indefinitely until the user takes action to indicate the powered-on status of the device. Audio interface 1274 is used to provide audible signals to and receive audible signals from the user. For example, in addition to being coupled to speaker 1225, audio interface 1274 may also be coupled to a microphone 1220 to receive audible input, such as to facilitate a telephone conversation. In accordance with embodiments of the present invention, the microphone 1220 may also serve as an audio sensor to facilitate control of notifications, as will be described below. System 1202 may further include video interface 1276 that enables an operation of on-board camera 1230 to record still images, video stream, and the like.

A mobile computing device implementing system 1202 may have additional features or functionality. For example, the device may also include additional data storage devices (removable and/or non-removable) such as, magnetic disks, optical disks, or tape. Such additional storage is illustrated in FIG. 12B by storage 1268. Computer storage media may include volatile and nonvolatile, removable and non-removable media implemented in any method or technology for storage of information, such as computer readable instructions, data structures, program modules, or other data.

Data/information generated or captured by the device 1200 and stored via the system 1202 may be stored locally on the device 1200, as described above, or the data may be stored on any number of storage media that may be accessed by the device via the radio 1272 or via a wired connection between the device 1200 and a separate computing device associated with the device 1200, for example, a server computer in a distributed computing network such as the Internet. As should be appreciated such data/information may be accessed via the device 1200 via the radio 1272 or via a distributed computing network. Similarly, such data/information may be readily transferred between computing devices for storage and use according to well-known data/information transfer and storage means, including electronic mail and collaborative data/information sharing systems.

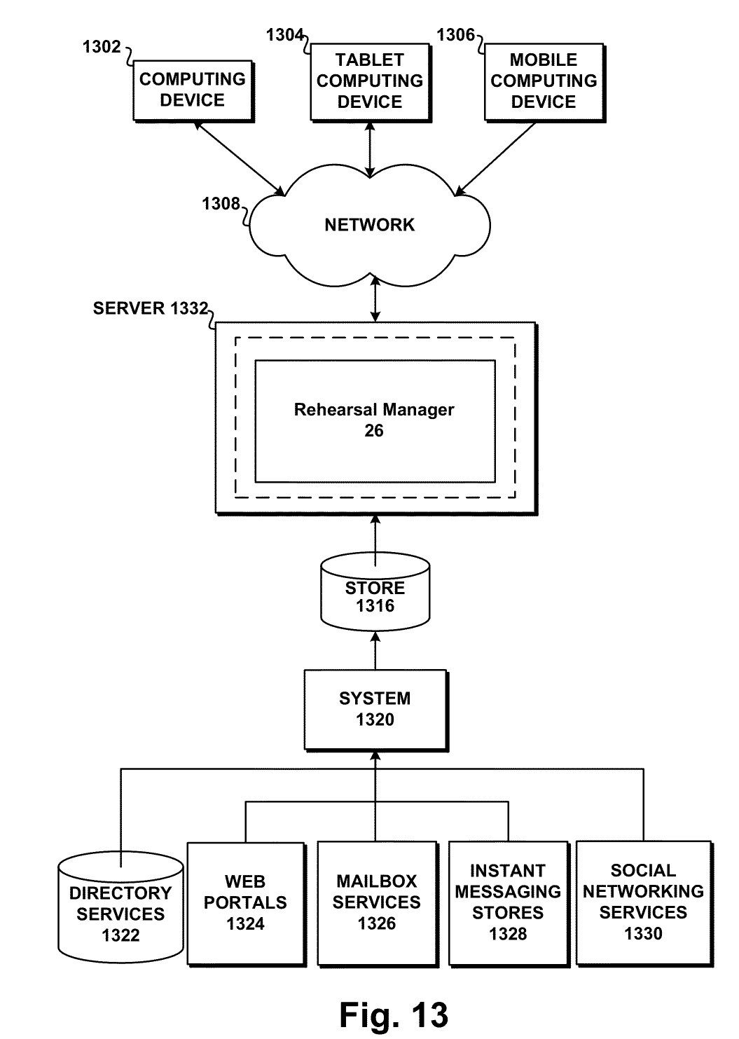

FIG. 13 illustrates a system architecture for using an interactive performance assessment after rehearsing a presentation assessment.

Components managed via the rehearsal manager 26 may be stored in different communication channels or other storage types. For example, components along with information from which they are developed may be stored using directory services 1322, web portals 1324, mailbox services 1326, instant messaging stores 1328 and social networking sites 1330. The systems/applications 26, 1320 may use any of these types of systems or the like for enabling management and storage of components in a store 1316. A server 1332 may provide communications and services relating to creating an application using shared code across different platforms. Server 1332 may provide services and content over the web to clients through a network 1308. Examples of clients that may utilize server 1332 include computing device 1302, which may include any general purpose personal computer, a tablet computing device 1304 and/or mobile computing device 1306 which may include smart phones. Any of these devices may obtain display component management communications and content from the store 1316.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for rehearsing a presentation and displaying a performance assessment, comprising:
determining a time spent on portions of the presentation during the rehearsal;
displaying an interactive performance assessment for the rehearsal including a graphical indicator of each portion and the time spent on each portion of the presentation during the rehearsal;
determining when an input is received that interacts with one of the displayed graphical indicators representing one of the portions of the presentation displayed on the interactive performance assessment; and
in response to the input, adjusting the display of the interactive performance assessment.

2. The method of claim 1, further comprising receiving an input to enter a rehearsal mode on a mobile device and in response to entering the rehearsal mode displaying a rehearsal view for the presentation comprising a timer that indicates a running time for the rehearsal of the presentation on the mobile device.

3. The method of claim 1, wherein displaying the interactive performance assessment comprises displaying a chart comprising a visual indication of each portion of the presentation that is sized in response to the time spent on the corresponding portion.

4. The method of claim 1, wherein determining the input that interacts with the performance assessment comprises performing at least one of: expanding a display of at least a portion of the interactive performance assessment that displays a drill down view of at least one of the portions; changing the portions that are displayed; moving a portion to another location within the presentation and deleting a portion within the presentation.

5. The method of claim 4, further comprising receiving a selection of at least one of the portions of the presentation and receiving input that is used to adjust a time target for the selected portion including changing a size of the displayed indicator that corresponds to the selected portion.

6. The method of claim 1, further comprising receiving a selection during the rehearsal that tags the portion and displaying the tagged portion differently from non-tagged portions in the interactive performance assessment display.

7. The method of claim 6, wherein displaying the performance assessment visualization comprises displaying an indicator that shows that the portion was tagged.

8. The method of claim 2, wherein each portion is a slide of a presentation and wherein the drilled down view displays at least a portion of the slides within a thumbnail along with a time spent on each of the slides.

9. The method of claim 1, further comprising displaying an option at an end of the rehearsal indicating a time of the rehearsal and an option to enter a review mode that when selected displays the performance assessment.

10. A computer-readable medium storing computer-executable instructions for assisting in delivery of a presentation including slides, comprising:
during the rehearsal of the presentation, determining a time spent on each of the slides;
in response to a completion of the rehearsal, displaying a total time spent during the rehearsal and an option to display an interactive performance assessment for the rehearsal of the presentation;
in response to receiving a selection of the option, displaying the interactive performance assessment for the rehearsal including a display of a selectable and adjustable graphical indicator for each slide including a time spent on the slide;
determining when one of the graphical indicators is interacted with using a touch gesture; and
in response to the interaction performing at least one of: adjusting a desired time to spent on the slide during the presentation and displaying additional information relating to the slide.

11. The computer-readable medium of claim 10, further comprising receiving an input to enter a rehearsal mode and in response to entering the rehearsal mode displaying a rehearsal view for the presentation comprising a timer that indicates a running time for the rehearsal of the presentation and displaying a tag option that when selected during the rehearsal tags the slide.

12. The computer-readable medium of claim 10, wherein displaying the interactive performance assessment comprises displaying a graph that comprises a time axis indicating a time spent on each slide and a slide axis that provides a location for each of the graphical indicators to be displayed, wherein the graphical indicator is a bar that is sized in response to the time spent on the corresponding portion.

13. The computer-readable medium of claim 10, wherein determining the input that interacts with the performance assessment comprises expanding a display of at least a portion of the interactive performance assessment that displays a drill down view of at least a portion of one of the portions in response to receiving a touch gesture that is associated with displaying the drill down view.

14. The computer-readable medium of claim 13, further comprising receiving a selection of at least one of the bars and receiving a touch based drag gesture that is used to adjust a target time for the slide that is associated with the bar.

15. The computer-readable medium of claim 10, wherein displaying the performance assessment comprises displaying an indicator that shows that the portion was tagged.

16. The computer-readable medium of claim 10, wherein each portion is a slide of a presentation and wherein the drilled down view displays at least a portion of the slides as a thumbnail along with a time spend on each of the slides.

17. A system for assisting in rehearsal of a presentation, comprising:
a display that is configured to receive touch input;
a processor and memory;
an operating environment executing using the processor;
a display; and
a rehearsal manager that is configured to perform actions comprising:
determining a time spent on each portion of the presentation;
automatically displaying an interactive performance assessment for the rehearsal including a display of a selectable and adjustable graphical indictor for each portion of the presentation including a time spent on the portion;
determining when one of the graphical indicators is interacted with though a gesture; and
in response to the interaction performing at least one of: adjusting a desired time to spent on the portion during the presentation and displaying additional information relating to the portion.

18. The system of claim 17, wherein displaying the interactive performance assessment comprises displaying a graph that comprises a time axis indicating a time spent on each slide associated with the portion of the presentation and a slide axis that provides a location for each of the graphical indicators to be displayed, wherein the graphical indicator is a bar that is sized in response to the time spent on the corresponding portion.

19. The system of claim 17, wherein determining the input that interacts with the performance assessment comprises expanding a display of at least a portion of the interactive performance assessment that displays a drill down view of at least one of the portions.

20. The system of claim 19, further comprising receiving a selection of at least one of the bars and receiving a drag selection that is used to adjust a target time for the slide that is associated with the bar.
